(19) United States
(12) Patent Application Publication
(10) Pub. No.: US 2013/0101310 A1
(43) Pub. Date: Apr. 25, 2013

(54) IMAGE FORMING APPARATUS

(71) Applicants: Shinichi KAWABATA, Tokyo (JP); Naoto YOSHIDA, Tokyo (JP)

(72) Inventors: Shinichi KAWABATA, Tokyo (JP); Naoto YOSHIDA, Tokyo (JP)

(73) Assignee: KONICA MINOLTA BUSINESS TECHNOLOGIES, INC., Tokyo (JP)

(21) Appl. No.: 13/609,337

(22) Filed: Sep. 11, 2012

(30) Foreign Application Priority Data
Oct. 25, 2011 (JP) 2011-233859

(51) Int. Cl. G03G 21/20

(52) U.S. Cl. 399/92

(57) ABSTRACT

The image forming apparatus according to the present embodiment has a fixing part, a drawer, a case member, and an exhaust duct 71. The fixing part is equipped with a fixing member for transporting a sheet of paper on which a toner image is transferred while heating and pressing the sheet of paper in order to fix the image and a blowing part for blowing air to a nipping part N of the fixing member. The drawer electrically connects the fixing part with the main unit of the image forming apparatus. The case member communicates with the fixing part and contains the drawer. The exhaust duct guides the air inside the case member to the outside of the image forming apparatus. The case member is equipped on one side facing the exhaust duct with an opening H that guides the air inside the case member to the exhaust duct.

### CROSS-REFERENCE TO RELATED APPLICATION

This application is based on Japanese Patent Application No. 2011-233859 filed on Oct. 25, 2011, the contents of which are incorporated herein by reference.

### BACKGROUND

1. Technical Field

The present invention relates to an image forming apparatus.

2. Description of Related Arts

In an image forming apparatus such as a copying machine, printer, or facsimile machine, a toner image transferred onto printing paper is fixed under heat and pressure while the paper is passing through a fixing member. The paper on which the image is fixed then leaves the fixing member and is discharged to the outside of the image forming apparatus.

When the toner image transferred on the printing paper is heated and pressed, it occurs sometime that the toner melts to cause the paper to stick to the fixing member. In particular, it becomes more difficult to separate the paper from the fixing member when the paper is thin or when a large amount of toner is used. In order to prevent the sheet from sticking to the fixing member, an image forming apparatus typically has a paper separating means for separating the printing paper from the fixing member. For example, the Japanese Unexamined Publication No. 2009271345 discloses an image forming apparatus that separates the printing paper, on which the image is fixed, from the fixing member by blowing air to the paper on the fixing member.

However, in the image forming apparatus of the above-mentioned Japanese Unexamined Publication No 2000-271345, the air blown on to the paper and heated by the fixing member flows along the fixing member to disperse into the inside of the image forming apparatus. As a result, each constituting member of the image forming apparatus located in the vicinity of the fixing member may get damaged by the heat. The present invention was made to solve such a problem. The object of the present invention is to provide an image forming apparatus capable of suppressing the air heated by the fixing member from getting dispersed into the inside of the image forming apparatus.

### SUMMARY

To achieve at least one of the above-mentioned objects, an image forming apparatus reflecting one aspect of the present invention comprises: a fixing part equipped with a fixing member that transports a sheet of paper on which a toner image is transferred while heating and pressing the sheet of paper in order to fix the image and a blowing part that blows air to a nipping part of said fixing member; a drawer that electrically connects said fixing part with the main unit of said image forming apparatus; a case member that communicates with said fixing part and contains said drawer; and an exhaust duct that conducts the air inside said case member to the outside of said image forming apparatus, wherein said case member is equipped with an opening on one side thereof facing said exhaust duct for conducting the air inside said case member to said exhaust duct.

Said case member is preferably equipped with an opening on another side of said case member.

Said image forming apparatus preferably further comprises an exhausting part for sucking the air inside said exhaust duct and discharging it to the outside of said image forming apparatus.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is an abbreviated cross-sectional view of an image forming apparatus according to a first embodiment of the present embodiment seen from the frontal side.

FIG. 2A is a perspective view of a main-unit-side connecting part, a fixing part, and an exhaust part of a first embodiment of the present invention seen from the back side of the image forming apparatus.

FIG. 2B is a cross-sectional view along A-A line of FIG. 2A.

FIG. 3 is a perspective view of a main-unit-side connecting part, a fixing part, and an exhaust part of a second embodiment of the present invention seen from the backside of the image forming apparatus.

### DETAILED DESCRIPTION

The embodiments of this invention will be described below with reference to the accompanying drawings.

### First Embodiment

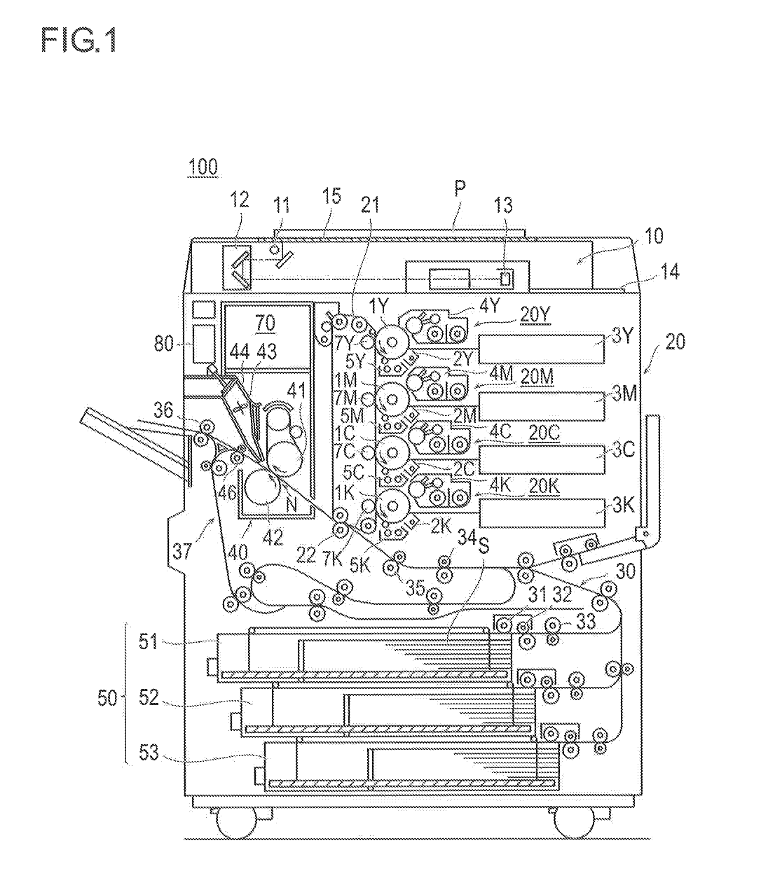

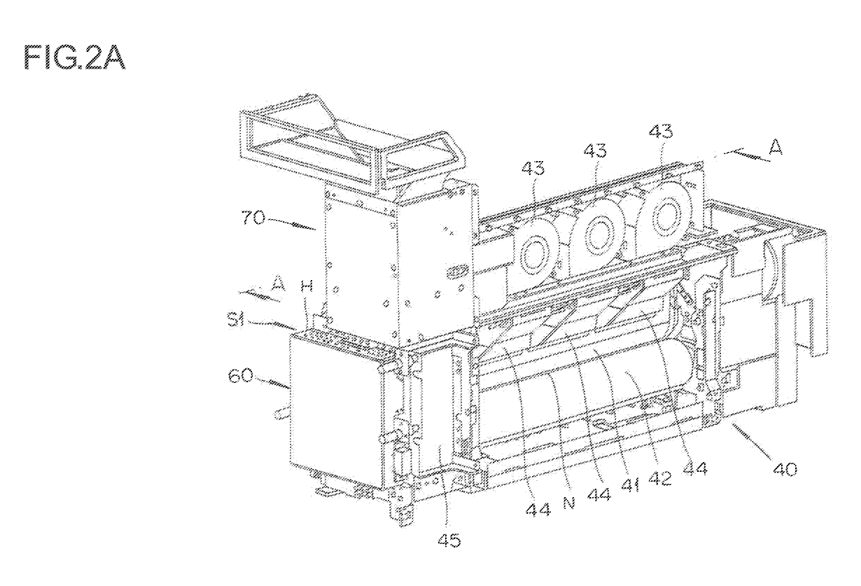

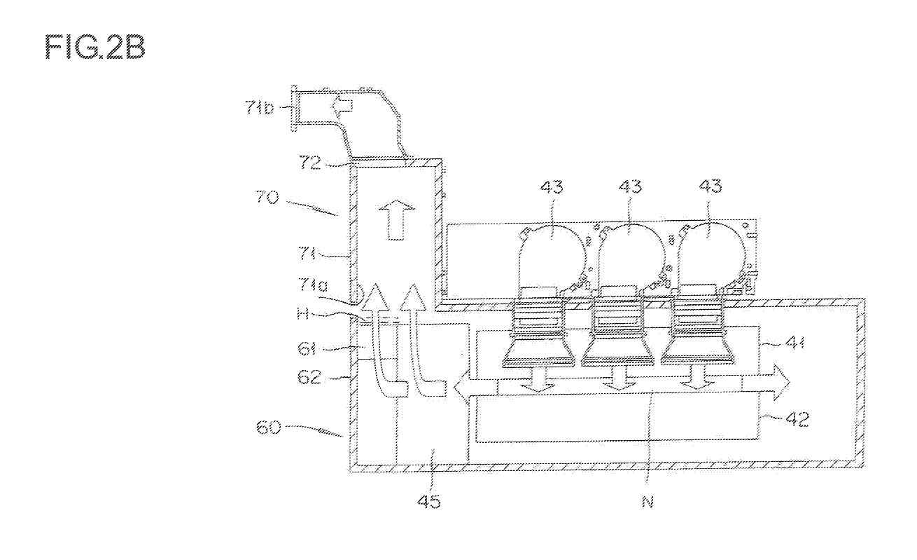

The first embodiment of the present invention will be described below with reference to FIG. 1, FIG. 2A, and FIG. 2B. FIG. 1 is an abbreviated cross-sectional view of an image forming apparatus according to a first embodiment of the present embodiment seen from the frontal side. The image forming apparatus of the present embodiment is characterized in that a case member that contains a drawer that electrically connects the fixing part and the main unit of the image forming apparatus serves as a part of the wind passage for exhausting the air from the fixing part. The image forming apparatus according to the present embodiment can be applied to copying machines, printers, facsimile machines, and MFPs. In describing the present embodiment, a copying machine is used as the example of the image forming apparatus.

As shown in FIG. 1, the image forming apparatus 100 of the present embodiment has a document scanning part 10, an image forming part 20, a paper transport part 30, a fixing part 40, a paper supply part 50, a main-unit-side connecting part (refer to FIG. 2A and FIG. 2B), an exhaust part 70, and a control part 80. The following description will focus on the major composition of the image forming apparatus 100 of the present embodiment, and omit the description of the compositions identical to those of the conventional image forming apparatuses.

The image scanning part 10 scans the image of the document and stores it. The image scanning part 10 is equipped with a light source 11, an optical system 12, an imaging element 13, and an image processing circuit 14.

The light radiating from the light source 11 is reflected from a document P placed on a scanning plane 15, and the reflected light focuses via a lens and a reflection mirror of the optical system 12 on an imaging element 13 that is now moved to the scanning position. The imaging element 13 generates electric signals depending on the intensity of the light reflected from the document P. The generated electric signals are treated by a compensation process, a filtration process, an image compression process, and the like after having been converted from analog signals to digital signals in the image processing circuit 14, and are stored in the memory of the image processing circuit 14 as image data.

The image forming part 20 forms images by means of the electrophotographic process. The image forming part 20 of the present embodiment comprises an image forming part 20Y that forms an yellow (Y) color image, an image forming part 20M that forms a magenta (M) color image, an image forming part 20C that forms a cyan (C) color image, and an image forming part 20K that forms a black (K) color image. Here the common code 20 is followed by another code, Y, M, C, or K, which signifies the color of the corresponding signal.

The image forming part 20Y consists of a rotary member, i.e., a photoreceptor drum 1Y, a charging part 2Y provided on the periphery thereof an optical writing part 3Y. a developing device 4Y, and a drum cleaner 5Y. The photoreceptor drum 1Y rotates at a specified speed driven by a drum motor.

Similarly, the image forming part 20M consists of a charging part 2M provided on the periphery of the photoreceptor drum 1M, an optical writing part 3M, a developing device 4M, and a drum cleaner 5M. Also, the image forming part 20C consists of a charging part 2C provided on the periphery of the photoreceptor drum 1C, an optical writing part 3C, a developing device 4C, and a drum cleaner 5C. Also, the image forming part 20K consists of a charging part 2K provided on the periphery of the photoreceptor drum 1K, an optical writing part 3K. a developing device 4K, and a drum cleaner 5K.

The photoreceptor drums 1Y, 1M, 1C, and 1K, the charging parts 2Y, 2M, 2C, and 2K, the optical writing parts 3Y, 3M, 3C, and 3K, the developing devices 4Y, 4M, 4C, and 4K, as well as the drum cleaners 5Y, 5M, 5C, and 5K, all of which corresponding to the image forming parts 20Y, 20M, 20C, and 20K respectively are constituted with identical components. Therefore, they are sometimes treated in the following descriptions without specific codes Y, N, C, and K when it is not necessary to show their distinctions.

The image forming part 20 forms a latent image on the photoreceptor drum 1 by writing image information signals on the photoreceptor drum 1 with the optical writing part 3 based on the image data stored in the memory of the image processing circuit 14. The latent image is developed by the developing device 4 to form a toner image as a visible image on the photoreceptor drum 1.

Yellow (Y), magenta (M), cyan (C), and black (K) images are formed on the photoreceptor drums 1Y, 1M, 1C, and 1K of the image forming parts 20Y, 20M, 20C, and 20K respectively.

An intermediate transfer belt 21 is supported and driven to go around continuously by a plurality of rollers. The toner image of each color formed by the image forming parts 20Y, 20M, 20C, and 20K respectively is transferred one by one onto the running intermediate transfer belt 21 by means of the primary transfer parts 7Y, 7M, 7C, and 7K to form a color image consisting of Y (yellow), M (magenta), C (cyan), and K (black) color layers overlaid one on top of each other.

The paper transport part 30 transports the printing paper S. The printing paper S is stored in a paper supply tray 51, 52 or 53 of the paper supply part 50. The paper transport part 30 is equipped with a release roller 31, a handling roller 32, a transport roller 33, a loop roller (intermediate roller) 34, a resist roller 35, a paper discharge roller 36, and a paper turning part 37.

The printing papers is sent out from the paper supply tray 51, 52, or 53 by means of the release roller 31 and separated into individual sheets by the handling roller 32. The printing paper S separated into individual sheets is transferred to a secondary transfer roller 22 via a loop roller 34 and a resist roller 35 along a transfer route by means of the transport roller 33.

The color image on the intermediate transfer belt 21 is transferred onto the printing paper S. The fixing part 40 applies heat and pressure on the printing paper S on which the color image is transferred to fix the toner image, after which the printing paper s is discharged via the paper discharge roller 36 to the outside of the image forming apparatus 100.

The image forming apparatus 100 is equipped with the paper turning part 37 so that it can guide the printing paper S on which the fixation is completed from a fixation transport roller 46 to the paper turning part 37 to have it flipped over before discharging it. Thus it is capable of forming images on both sides of the printing paper S.

The fixing part 40 has a heating roller 41, a pressure roller 42, a blower fan 43, a nozzle 44, and a fixing-side connecting part 45.

The heating roller 41 heats the printing paper S on which the toner image is transferred while it is being transported. The heating roller 41 is formed by coating the surface of a cylindrically formed core metal made of aluminum, iron and other metals with a mold releasing layer containing fluorine resins such as PFA (perfluoroalkoxy), PTFE (polytetrafluoroethylene), etc. The heating roller 41 contains a heating part such as a halogen heater. In case of the present embodiment, the heating roller 41 rotates clockwise as shown by the arrow in the drawing.

The pressure roller 42 applies pressure to the printing paper S on which the toner image is transferred while it is being transported. The pressure roller 42 is formed by coating a cylindrically formed core metal made of stainless and other metals with an elastic layer containing a foaming agent such as silicon rubber and a mold separating layer. The pressure roller 42 applies pressure from underneath energized by an energizing member (not shown). In the meanwhile a nipping member N is formed as the pressure roller 42 makes a pressuring contact with the heating roller 41. The pressure roller 42 rotates counterclockwise opposite to the rotation of the heating roller 41. As such, the heating roller 41 and the pressure roller 42 function as the members of the fixing unit and apply heat and pressure to the printing paper S on which the toner image is transferred simultaneous with the transportation of the printing paper S.

The blower fan 43 sends out a specified amount of air towards the nozzle 44. In the present embodiment, the blower fan 43 functions as a blowing part and is controlled to rotate at a specified speed by the control part 80. A sirocco fan, for example, can be used as the blower fan 43.

The printing paper S on which the toner image is transferred is sent into the nipping part N of the fixing part 40 thus constituted. The printing paper S sent into the nipping part N advance from the paper outlet port of the nipping part N toward the fixation transport roller 46 after the image is fixed by means of the heating roller 41 and the pressure roller 42 simultaneous with its transportation. On the other hand, in the nozzle 44, the air sent out from the blower fan 43 increases its speed as it is compressed inside the nozzle 44 and is ejected toward the printing paper S at the paper outlet of the nipping part N. Consequently, the printing paper S is separated from the heating roller 41.

Moreover, in the present embodiment, the fixing part 40 can be removed from the image forming apparatus 100 to be replaced. By moving the fixing pat 40 towards the frontal side of the paper in FIG. 1, it becomes possible to make the fixing part 40 removable from the image forming apparatus 100, while the fixing part 40 can be attached to the image forming apparatus 100 by moving the fixing part 40 towards the rear side of the paper in FIG. 1. The main unit of the image forming apparatus 100 and the fixing part 40 are electrically connected with the fixing side connecting part and the main-unit-side connecting part provided on the backside of the image forming apparatus 100. The main-unit of the image forming apparatus 100 here means the entire constitution of the image forming apparatus 100 less the fixing part 40.

The main-unit-side connecting part and the fixing side connecting part are described below referencing FIG. 2A and FIG. 2B-FIG. 2A is a perspective view of the main-unit-side connecting part, the fixing part, and the exhaust part seen from the backside of the image forming apparatus, while FIG. 2B is an abbreviated cross-sectional drawing taken along the line A-A of FIG. 2A, FIG. 2A and FIG. 2B show a state in which the main-unit-side connecting part and the fixing side connecting part are connected.

As shown in FIG. 2A, the fixing side connecting part 45 of the present embodiment is provided on the lines extended along the lengthwise direction of the heating roller 41 and the pressure roller 42 of the fixing part 40, and is connected with the main-unit-side connecting part 60. When the fixing part 40 is removed from the image forming apparatus 100, the fixing side connecting part 45 is separated from the main-unit-side connecting part 60, so that the main unit of the image forming apparatus 100 becomes electrically disconnected from the fixing part 40.

The fixing side connecting part 45 has motors that drive the heating roller 41 and the pressure roller 42, a drive circuit that drives the motors, power supply wiring that supplies power to the particular drive circuit and the heater of the heating roller 41, and control signal wiring for controlling constitutions such as the drive circuits and other constituents of the fixing part 40. These and other circuits and wiring are contained in a case.

As shown in FIG. 2E, in the present embodiment, the air blown onto the nipping part N by the blower fan 43 flows along the longitudinal direction of the heating roller 41 and the pressuring roller 42 (see the arrows shown in FIG. 2B). In this case, the air inside the fixing part 40 is heated typically up to about 210-220 degree Celsius. The air that flows to the right of FIG. 2B diffuses into the inside of the fixing part. 40. On the other hand, the air that flows to the left flows into the fixing side connecting part 45. The air that enters into the fixing side connecting part 45 flows partially into the main-unit-side connecting part 60, while the rest of it flows into the exhaust part 70.

The main-unit-side connecting part 60 has a power circuit and power supply wiring for supplying power from the main unit of the image forming apparatus 100 to the fixing part 40, and a communication circuit and communication wiring for sending and receiving electrical signals between the main unit of the image forming apparatus 100 and the fixing part 40.

Moreover, the main-unit-side connecting part 60 has a drawer 61 that electrically connects the fixing part 40 with the main unit of the image forming apparatus 100. More specifically, the drawer 61 is equipped with an electric contact part (connectors) that electrically connects wiring such as power supply wiring of the main-unit-side connecting part 60 and the fixing side connecting part 45 and communication wiring.

The power circuit, power supply wiring, communication circuit, communication wiring, drawer 61 and other items of the main-unit-side connecting part 60 are contained in a case member 62. The inside of the case member 62 communicates with the inside of the fixing part 40 and the fixing side connecting part 45. The case member 62 has a rectangular shape and is made of a metallic material with an excellent heat dissipation characteristic.

As shown in FIG. 2A, in the present embodiment, at least one opening H is formed on one side S1 of the case member 62 that faced the exhaust part 70. The air that enters into the main-unit-side connecting part 60 flows out of the opening H and further flows toward the exhaust part 70. Therefore, the air does not stagnate in the inside of the main-unit-side connecting part 60 so that the drawer 61 is prevented from becoming affected by the heat. In the present embodiment, the temperature inside the main-unit-side connecting part 60 can be lowered to 70 degree Celsius as a result of the air circulation inside the main-unit-side connecting part 60.

The number of openings H and their positions to be formed on the case member 62 are not limited specifically. It is preferable that the number of the openings H is as many as possible from the standpoint of efficiently ventilating the internal air of the main-unit-side connecting part 60. The diameter of the opening H shall be determined considering the protection of the drawer 61 stored in the case member 62 and the efficiency of the air ventilation.

The exhaust part 70 exhausts the air inside the main-unit-side connecting part 60 and the fixing side connecting part 45 to the outside of the image forming apparatus 100. The exhaust part 70 has an exhaust duct 71 and an exhaust fan 72. The exhaust fan 72 functions as an exhaust part and is controlled to rotate at a specified speed by the control part 80.

The exhaust duct 71 is located above the main-unit-side connecting part 60 and the fixing side connecting part 45 separated by a specified distance from the main-unit-side connecting part 60. The entrance 71a of the exhaust duct 71 is located to face against the opening H of the case member 62 so that the air flows out of the opening H enters into the exhaust duct 71 via the entrance 71a of the exhaust duct 71. The air that enters the exhaust duct 71 flows toward the exit 71b of the exhaust duct as it is sucked by the exhaust fan 72. On the other hand, the air that flows out from the fixing side connecting part 45 also enters the exhaust duct 71 via the entrance 71a of the exhaust duct 71 and flows toward the exit 71b of the exhaust duct sucked by the exhaust fan 72.

The control part 80 controls the image scanning part 10, the image forming part 20, the paper transport part 30, the fixing part 40, the paper supply part 50, and the exhaust part 70. The control part 80 is equipped with a CPU (Central Processing Unit), a RAM (Random Access Memory), and a ROM (Read Only Memory). The CPU controls the image scanning part 10, the image forming part 20, the paper transport part 30, the fixing part 40, the paper supply part 50, and the exhaust part 70, and stores the arithmetic results and others on the RAM in accordance with the software program stored in the ROM.

In the image forming apparatus 100 of the present embodiment constituted as described in the above, the air blown to the nipping part N by the blower fan 43 flows in the longitudinal direction of the heating roller 41 and the pressure roller 42, a portion of which flows into the fixing side connecting part 45 and the main-unit-side connecting part 60. The air inside the main-unit-side connecting part 60 flows into the exhaust duct 71 and flows toward the exit 71b of the exhaust duct via the opening H being sucked by the exhaust fan 72. On the other hand, the air that flows out from the fixing side connecting part 45 also enters the exhaust duct 71 and flows toward the exit 71b of the exhaust duct sucked by the exhaust fan 72.

The present embodiment described above provides the following effects:

(a) According to the image forming apparatus 100 of the present invention, the case member 62 that contains the drawer 61 communicates with the fixing part 40, and is equipped with the opening H that conducts the air inside the case member 62 toward the exhaust duct 71 on one side of it that faces the exhaust duct 71. Therefore, the air entering from the fixing part 40 can be efficiently exhausted to the outside of the image forming apparatus 100, so that the air heated by the heating roller 41 can be prevented from dispersing into the inside of the image forming apparatus 100. As a result, each constituting member of the image forming apparatus 100 located in the vicinity of the fixing part 40 can be prevented from getting damaged by the heat.

(b) As the exhaust part 70 is equipped with the exhaust fan 72, the air inside the exhaust duct 71 can be efficiently exhausted to the outside of the image forming apparatus 100.

### Second Embodiment

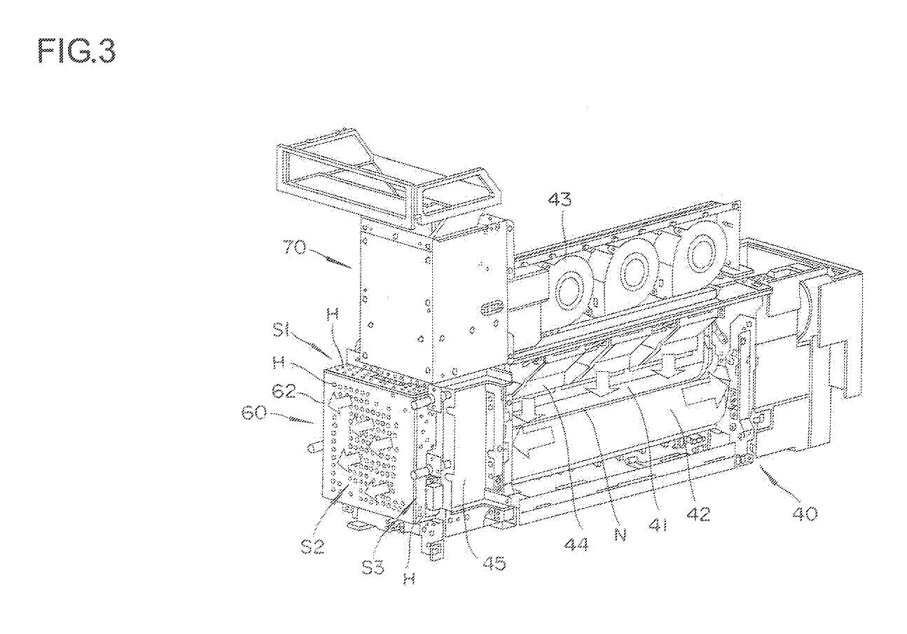

In the second embodiment, the case member of the main-unit-side connecting part has an opening on another side as well in addition to the side facing the exhaust part. The main-unit-side connecting part of the image forming apparatus according to the second embodiment of the present invention is described referencing FIG. 3, FIG. 3 is a perspective view of a main-unit-side connecting part, a fixing part, and an exhaust part of the present embodiment seen from the backside of the image forming apparatus. The constitution of the image forming apparatus of the present embodiment is identical to the constitution of the image forming apparatus of the first embodiment except the fact that it has an opening on another side in addition to the side that faces the exhaust part, so that the description of its constitution other than the main-unit-side connecting part is omitted here.

As shown in FIG. 3, the case member 62 of the main-unit-side connecting part 60 of the present embodiment has at least another opening H on another side S2 and/or S3 in addition to the side S1 that faces the exhaust part 70. Openings H can be provided on the sides opposite to the side S1 and the side S3 of the case member 62 as well.

In an image forming apparatus equipped with the main-unit-side connecting part 60 constituted as such, if the exhaust fan 72 is not operating, the air blown on to the nipping part N by the blower fan 43 flows along the longitudinal direction of the heating roller 41 and the pressure roller 42, while a portion of which is exhausted directly to the outside of the fixing part 40 via the opening(s) H formed on the case member 62 of the main-unit-side connecting part 60 (refer to the arrows of FIG. 3). Thus, the air is prevented from stagnating inside the main-unit-side connecting part 60.

On the other hand, if the exhaust fan 72 is operating, the majority of the air existing inside the main-unit-side connecting part 60 flows toward the exit 71b sucked by the exhaust fan 72. Consequently, the amount of air that is exhausted to the outside of the fixing part 40 directly via the opening(s) H is quite limited, if the exhaust fan 72 is operating.

As can be seen from the above, the present embodiment provides the following effects in addition to the effects provided by the first embodiment:

(c) Since the air inside the main-unit-side connecting part 60 is directly exhausted to the outside of the fixing part 40 via the opening(s) H, the stagnation of the air inside the main-unit-side connecting part 60 can be prevented even when the exhaust fan 72 is not operating. Consequently, the drawer 61 can be prevented from being damaged by the heat.

Such is the configurations of the image forming apparatuses according to these embodiments. However, it goes without saying that the present invention can arbitrarily added, modified and omitted by a person skilled in the art within the gist of the technology disclosed herein.

For example, it was described in the first and second embodiments that the air blow onto the nipping part for separating paper from the heating roller is exhausted outside of the image forming apparatus. However, rather than limited to the above-mentioned constitutions, the present invention can be applied to other constitutions where the blowing part is provided inside the fixing part.

What is claimed is:

1. An image forming apparatus comprising:
a fixing part equipped with a fixing member that transports a sheet of paper on which a toner image is transferred while heating and pressing the sheet of paper in order to fix the image and a blowing part that blows air to a nipping part of said fixing member;
a drawer that electrically connects said fixing part with the main unit of said image forming apparatus;
a case member that communicates with said fixing part and contains said drawer; and
an exhaust duct that conducts the air inside said case member to the outside of said image forming apparatus, wherein said case member is equipped with an opening on one side thereof facing said exhaust duct for conducting the air inside said case member to said exhaust duct.

2. In the image forming apparatus claimed in claim 1, said case member is equipped with an opening on another side thereof.

3. The image forming apparatus claimed in claim 1 further comprises:
an exhausting part for sucking the air inside said exhaust duct and discharging it to the outside of said image forming apparatus.
